(19) United States
(12) Patent Application Publication
(10) Pub. No.: US 2011/0311774 A1
(43) Pub. Date: Dec. 22, 2011

(54) COLOR-COATINGS OF ENHANCED SOLAR REFLECTANCE AND THERMAL EMITTANCE FOR METALLIC FLAKES/AGGREGATE USED IN ROOFING APPLICATIONS

(76) Inventors: Anit Giri, Bel Air, MD (US); Ingo B. Joedicke, Falling Waters, WV (US)

(21) Appl. No.: 13/156,617

(22) Filed: Jun. 9, 2011

Related U.S. Application Data
(60) Provisional application No. 61/355,372, filed on Jun. 16, 2010.

(51) Int. Cl. E04D 7/00; B05D 5/06; F21V 9/04

(52) U.S. Cl. 428/144; 252/587; 427/160

(57) ABSTRACT

Colored metal particles comprising a) metallic base particles; and b) an insolubilized coating material at least partially covering said particles comprising: an IR-reflective pigment; and a silicate-clay matrix formed from the high-temperature interaction between an alkali metal silicate and kaolin clay; and a method for the preparation thereof.

### FIELD

The present application relates to color-coatings of enhanced solar reflectance and thermal emittance for metallic flakes/aggregates used in roofing applications. More particularly, the present application relates to colored metal particles comprising base metallic particles and an insolubilized coating material covering the base metallic particles.

### BACKGROUND

Interest in roofing of increased solar reflectance has gained momentum in recent years as a way to reduce summer cooling costs and to mitigate smog-producing urban “heat island” effects. The EPA Energy Star Initiative requires steep-slope residential roofing (e.g. asphalt shingles) to have a minimum solar reflectance of 0.25 initially and a 3-year aged solar reflectance of at least 0.15. Low slope roofing according to Energy Star must have an initial solar reflectance of 0.65 and a 3-year aged solar reflectance of at least 0.50. EPA Energy Star thermal emittance requirement for roofing (regardless of type and age) is 0.75 minimum. California's Title 24 Initiative requires 3-year aged reflectance minimums of 0.20 for steep slope roofing, 0.70 for low slope roofing, and similarly requires a thermal emittance minimum of 0.75. Conformance to these reflectance and emittance requirements is possible for many types of asphalt shingles. Standard shingles surfaced with light-colored roofing granules typically exhibit solar reflectance values of 0.25 to 0.35 and thermal emittance values of 0.87-0.92. Recently, highly reflective dark roofing granules have been developed that make the manufacture of asphalt shingles of rich dark browns, grays, and earth-tone shades possible. For example, ISP Minerals' Solar Shield is a product line of richly-colored, highly reflective roofing granules that can be used to produce asphalt shingle products with typical solar reflectance values of 0.20 to 0.30 and typical thermal emittance values of 0.85 to 0.90.

It would be desirable to reduce the weight of asphalt shingles in order to lower shipping costs of roofing products in general. The use of light-weight metallic flakes, such as aluminum, in lieu of conventional granules is one method that could be used to reduce weight. Some of the advantages that may result by using metallic aluminum flakes in place of conventional mineral roofing granules include the following:

1. Light weight (5 lbs. of aluminum flake can cover the same area (100 sq ft.) as 35 lbs. of granules)
2. High reflectance
3. Compatible surface for coloring
4. Adheres well to asphalt

### 5. Weather-resistant

However, metallic aluminum flakes cost more and provide lower thermal emittance as compared to mineral granules. The cost is offset, at least partially, by the lower usage rate needed for asphalt coverage. The low thermal emittance of metallic aluminum (typically=0.11) is significantly increased upon application of a suitable coating. Therefore, the present application discloses a weather-resistant coating for metallic aluminum so that the resulting flakes will be of rich color, high reflectance, high thermal emittance, and can be used as a light-weight alternative to mineral roofing granules.

### DETAILED DESCRIPTION

The present application relates to colored metal particles comprising base metallic particles that have been coated with an inorganic composition containing an alkali silicate binder, IR-reflective pigments/materials, and kaolin clay such that the coating will be insolubilized through heat treatment to form a colored, highly reflective, and emissive particle or aggregate suitable for use as an asphalt roofing surfacing material. The base metal can be aluminum, zinc, copper, tin, brass, bronze, stainless steel, or various similar metals, alloys, and/or composites thereof. The shape of the base metal can be cubical, spherical, flake, or irregular. The size of the metal particles or aggregates can be similar to that of mineral aggregates commonly used in roofing applications. This typically ranges from as coarse as 8 mesh (2.5 mm diameter) to as fine as 40 mesh (0.4 mm diameter). The final color, solar reflectance, and thermal emittance of the coated metal flake or aggregate can be adjusted by controlling the amounts and types of IR-reflective pigment in the coating, by optimizing the distribution of the coating to maximize coverage, and by controlling the amount and thickness of coating applied.

A. Coating Composition

The base metal is coated with a semi-ceramic composition comprising a pigmented, weather-resistant, silicate-clay matrix formed from the high temperature interaction between an alkali metal silicate and kaolin clay.

The alkali metal silicate can be sodium silicate, potassium silicate, or combinations thereof. From a cost standpoint, sodium silicate is preferred in a weight ratio range of SiO₂/Na₂O of between 2.0 to 3.2, more particularly 2.5-3.0, with a weight ratio of 2.8 considered optimum. In accordance with certain embodiments, this can be achieved by using Silicate K (PQ Corp.) or Silicate 47 (Oxychem) Solutions (approx. 42% Solids). Alternatively, a SiO₂/Na₂O weight ratio of 2.8 can be achieved cost effectively by combining Sodium Silicate Solution of SiO₂/Na₂O weight ratio of 3.22 (PQ Silicate N or Oxychem Grade 40) with Sodium Silicate Solution of SiO₂/Na₂O weight ratio 2.00 (PQ Silicate D or Oxychem Grade 50) in a ratio of SilN/SilD=3.5. Total Sodium Silicate solids may be present in the initial coating composition in amounts typically ranging from about 10% to 20% by weight.

The kaolin clay may be a hydrated kaolin that reacts with the alkali silicate during high-temperature firing to form insoluble complex aluminosilicates. In certain embodiments, the kaolin may be present in the coating composition in amounts ranging from about 75% to 150%, more particularly from about 90% to 130%, relative to the weight of alkali silicate solids and can be in the form of a dry powder or an aqueous slurry. A particularly useful slurry contains about 70% kaolin solids. The kaolin may be of small particle size, i.e. having a particle size distribution of at least 80% finer than 2.0 micron, to facilitate reactivity. A suitable Kaolin slurry for this application is Kamin 95 slurry from Kamin LLC. Another example of useful Kaolin is Royale Slurry R from Unimin Corp.

The pigments used to color the coating may be IR-reflective (cool) pigments to maximize reflectance of the IR portion of incident solar radiation. Dark IR-reflective pigments may be present in amounts ranging from about 0.0-20.0%, more particularly from about 3.0 to about 16.0%, and still more particularly from about 5.0 to about 12.0% by weight in the initial coating composition as applied. These pigments are generally of the mixed metal oxide types that include, but are not limited to, the following generic groups:

Zinc Iron Chromite

Iron Titanium Brown Spinel

Chromium Green-Black Hematite

Chromium Iron Oxide

Chromium Iron Nickel Black Spinel

Cobalt Chromite Green Spinel

Chromium Titantate Green Spinel

Cobalt Aluminate Blue Spinel

Cobalt Chromite Blue-Green Spinel

Particularly useful dark IR-reflective pigments include 9889 Black and 9770 Brown from BASF, both of which are of the Chromium Iron Oxide type. A variety of IR-reflective pigments can also be obtained from Ferro Corporation and from the Shepherd Color Co.

In addition, visible/IR-reflective (cool) and IR-transparent Light- and dark-colored metal oxides, commonly used as pigments and colorants, may also be employed, in amounts ranging from about 0.0 to 15.0%, more particularly from about 1.0 to about 14.0%, and still more particularly from about 2.0 to about 12.0% by weight by weight in the initial coating composition as applied, in conjunction with the IR-reflective dark pigments, for purposes of tinting and color adjustment. These include

Titanium Dioxide White (e.g. RCL-9 from Millenium)

Chrome Titanate Yellow (e.g. Heubach 6R)

Nickel Titanate Yellow

Zinc Ferrite Yellow (e.g. Lanxess Bayferrox 950)

Red Iron Oxide (e.g. Lanxess MPT1300)

Chrome Oxide Green (e.g. Elementis 4099)

Ultramarine Blue (e.g. Brenntag 5016)

Cobalt Blue (e.g. Shepherd 142)

The coating component may also contain a coarse, non-pigmentary Titanium Dioxide that is used to increase reflectance without significantly impacting dark pigmentation efficacy nor coating viscosity. The non-pigmentary TiO₂ may be present in amounts ranging from 0.0-15.0%, more particularly from about 1.0 to about 12.0% and still more particularly from about 3.0 to about 8.0% by weight in the initial coating formulation as applied. This type of TiO₂ is commonly referred to as “Enamel Grade” titanium dioxide, and is available in both Anatase and Rutile forms. It typically shows the following particle size distribution:

% Finer than 40 microns=100%

% Finer than 10 microns=50-100%

% Finer than 1 microns=0-15%

A non-pigmentary “Enamel Grade” Anatase suitable for use in the coating of this application is supplied by Special Materials Corporation under the product code SMC 1100.

The initial coating formulation as prepared using the raw materials above may be an aqueous alkali silicate formulation of 45% to 55% solids and viscosity of about 400-1000 centipoise, more particularly of about 550-900 centipoise, and still more particularly of about 700-850 centipoise. In this form, the coating formulation can be cost effectively shipped to point of use and easily remixed to reestablish proper dispersion of the pigments and other solids throughout the silicate paint. Just prior to use, the formulation can be diluted with water as necessary, typically to a paint to water ratio ranging from 70/30 to 30/70, to a solids content of 10% to 40%, and a final viscosity of less than 300 centipoise, to assure proper operation of the fluid bed coating equipment and optimum coating application during the metal flake coating process.

B. Coating Application Process

The metal flake or aggregate is fluidized in suitable fluid bed coating equipment. Optionally, the metal flake or aggregate can be preheated, typically to 180-210 deg. F. prior to coating.

The preheated metal flake or aggregate is then coated with a semi-ceramic paint composition to produce a coating of pleasing dark color, high solar reflectance, and a high degree of thermal emittance. Some typical non-limiting compositions are provided below:

| | Coating as Prepared | Coating as Applied |
|---|---|---|
| | (Before Dilution) | (After Dilution) |
| Water | 20-40% | 40-80% |
| Sodium Silicate N | 20-30% | 10-20% |
| Sodium Silicate D | 0-10% | 0-5% |
| IR-Reflective Dark Pigments | 0-30% | 0-20% |
| IR-Reflective Tint Pigments | 0-20% | 0-15% |
| Non-Pigmentary TiO₂ | 0-20% | 0-15% |
| Hydrated Kaolin Clay | 10-40% | 5-30% |

Cured Coating (on Aluminum Flake)—% by wt. Composition Ranges

| COATING | BROAD | INTERMEDIATE | NARROW |
|---|---|---|---|
| COMPONENT | RANGE | RANGE | RANGE |
| Sodium Silicate | 10-50% | 20-40% | 25-35% |
| Solids | | | |
| IR-Reflective Dark | 0-50% | 10-40% | 20-35% |
| Pigments | | | |
| IR-Reflective Tint | 0-35% | 0-25% | 5-15% |
| Pigments | | | |
| Non-Pigmentary TiO₂ | 0-30% | 5-25% | 10-20% |
| Fired Kaolin Clay | 15-50% | 20-40% | 25-35% |
| Solids | | | |

The coating components are combined into a slurry by means of suitable mixing equipment. The initial coating composition as prepared has a typical viscosity of 400-1000 centipoise. Before use in the fluid bed coating equipment, the coating is typically diluted with water so that the viscosity does not exceed 300 centipoise to assure that there will be no plugging of the paint spray nozzles in the fluid bed coating equipment.

Coating composition application is continued in the fluid bed coating equipment until the desired weight of coating solids has been applied. This determines the thickness of the coating which will subsequently affect the color, completeness of coverage, solar reflectance, and thermal emittance of the resulting coated metal surface. In general, for dark-colored coatings, application of more coating results in darker color, lower solar reflectance, and higher thermal emittance.

The uncured color-coated metal flakes or aggregates may be pre-dried by adjusting the temperature and airflow to reduce moisture content of the coating to between 0.2%-0.5%. The colored metal flakes at this point are free-flowing but the uncured coating has no weather-resistance. This can be demonstrated by immersing the uncured flakes in boiling water, which results in almost complete coating loss.

To properly cure the coating, the dried, color-coated metal flakes or aggregates are fired though a suitable kiln or oven to gradually bring the temperature from ambient up to between 800 and 1100° F., more particularly between 850 and 1050° F., and still more particularly between 900° F. and 1000° F., for a sufficient time period, to convert the coating to an insoluble silicate-clay matrix throughout which the IR-reflective pigments, the tint pigments, and the non-pigmentary TiO₂ particles are preferably uniformly distributed. The time period required to heat and insolubilize the matrix is not particularly limited and can depend on other aspects of the process. Typical time periods range from over a 20-minute period to over a 45-minute period, or even longer if necessary. In accordance with certain aspects, this fired coating will be highly weather-resistant with a high degree of solar reflectance and thermal emittance.

The present application is illustrated in more detail by the following non-limiting examples.

### EXAMPLES

Coating formulations were prepared in the lab using standard mixing equipment and the raw materials described above. These formulations were then coated on aluminum flake by means of a fluid bed Flo-Coater apparatus (Vector Corporation (Marion, Iowa)). Prior to processing in the Flo-Coater, these coating composition were diluted with water by 43% to 100% of their original concentration (by weight) to prevent spray nozzle clogging. This dilution range is equivalent to paint to water ratios ranging from 70/30 to 50/50. This dilution provided for continuous operation in this particular fluid-bed coating equipment. Analogous equipment from other suppliers may have other requirements. In the examples below, coating compositions are shown both prior to (formulation as initially prepared) and after dilution (formulation as applied to aluminum flake) for clarity.

Formulation (paint) viscosities were measured with a Brookfield Viscometer using spindle #3 at 60 rpm at ambient temperature.

The coatings were applied to the fluidized aluminum flakes until the desired coating weight gain was achieved. The coated flakes were subsequently cured by firing at elevated temperatures in a Blue M Drawdown Oven. A minimum 30 minute oven exposure time was typically sufficient to bring the temperature from ambient to between 600° F. and 950° F.

The degree of curing (i.e. insolubilization) of the coating was determined by measuring the extractable alkalinity by using the following procedure:
10.0 gm of coated aluminum flake were placed in an extraction thimble and leached for 18 hours with hot water in a soxhlet extraction apparatus. The resulting leachate was titrated to the phenolphthalein endpoint with 0.1N HCL and the residual alkalinity expressed as “ml 0.1N HCL required for neutralization.”

An extractable alkalinity of <20 ml indicates a significant level of coating insolubilization as evidenced by a high degree of resistance to coating loss during boiling water exposure.

The 900° F.-cured, color-coated aluminum flakes were embedded in asphalt that was layered onto a 6″×2.5″ aluminum panel to simulate a shingle surface and to facilitate measurement of color, reflectance, and emittance. Color was measured using a Hunter Labscan XE Colorimeter. Solar reflectance was measured using a Devices and Services model SSR-ER Reflectometer. Thermal emittance was measured using a Devices and Services model AE Emissometer.

Reflective Black Aluminum Flakes

The following black reflective coating composition, designated 340-Al, was prepared in the laboratory:

| | As Prepared | | As Applied | |
|---|---|---|---|---|
| | (Before Dilution) | | (After 70/30 Dilution) | |
| | % by Wt. | % Solids | % by Wt. | % Solids |
| Water | 25.8 | 0.0 | 48.0 | 0.0 |
| Sodium Silicate N | 26.9 | 10.3 | 18.8 | 7.2 |
| Sodium Silicate D | 7.7 | 3.2 | 5.4 | 2.2 |
| BASF 9889 IR-Black | 16.5 | 16.5 | 11.6 | 11.6 |
| Kamin 95 Kaolin Slurry | 23.1 | 16.2 | 16.2 | 11.3 |
| Total | 100.0 | 46.2 | 100.0 | 32.3 |

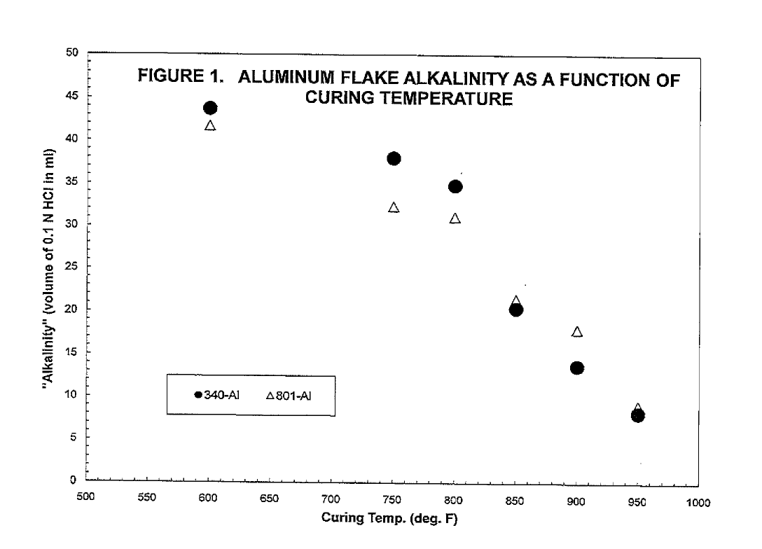

This initial coating composition exhibited a total solids content of 46.2% with a viscosity of 870 centipoise. After dilution with water at a 70/30 (paint to water) ratio to 32.3% solids and 150 centipoise viscosity, the diluted formulation was used to coat aluminum flake until a 30% weight gain was achieved. Individual samples of the coated flakes were then cured by oven firing at 600° F., 750° F., 800° F., 850° F., 900° F., and 950° F. A plot of Alkalinity vs Curing Temperature for aluminum flakes coated with the 340-Al coating is shown in FIG. 1. A curing temperature of 900° F. or higher is sufficient to adequately insolubilize (Alkalinity <20 ml) the coating.

The 900° F.-cured, color-coated flakes were evaluated for color, solar reflectance, and thermal emittance. These values are tabulated below as a comparison between bare aluminum flake and 340-Al colored flake to show the differences as a result of the coating process:

| Bare Aluminum Flake | 340-Al Blake-Reflective Flake |
|---|---|
| Hunter Color L = 62.2; | Hunter Color L = 27.5; |
| a = −0.3; b = 0.8 | a = 2.9; b = 1.6 |
| Solar Reflectance = 0.84 | Solar Reflectance = 0.33 |
| Thermal Emittance = 0.11 | Thermal Emittance = 0.67 |

As can be seen, emittance is significantly improved as a result of the 340-Al coating. In a subsequent trial, this same coating was similarly diluted to a 60/40 (paint to water) ratio to a 27.7% solids content and 90 centipoise viscosity as shown below:

| | As Prepared | | As Applied | |
|---|---|---|---|---|
| | (Before Dilution) | | (After 60/40 Dilution) | |
| | % by Wt. | % Solids | % by Wt. | % Solids |
| Water | 25.8 | 0.0 | 55.5 | 0.0 |
| Sodium Silicate N | 26.9 | 10.3 | 16.1 | 6.2 |
| Sodium Silicate D | 7.7 | 3.2 | 4.6 | 1.9 |
| BASF 9889 IR-Black | 16.5 | 16.5 | 9.9 | 9.9 |
| Kamin 95 Kaolin Slurry | 23.1 | 16.2 | 13.9 | 9.7 |
| Total | 100.0 | 46.2 | 100.0 | 27.7 |

This diluted formulation was similarly applied in the fluidized bed coater until a 30% aluminum flake weight gain was obtained. However, some preconditioning efforts were made to improve the degree of coating coverage and to eliminate clumping of the flakes during the coating process. Preconditioning involved flake fluidization in the absence of paint application, typically for 15 minutes. This resulted in a more completely coated, darker-colored flake with further improved emittance after 900° F. curing:

Darker 340-Al Black Reflective Flake

Hunter Color L=23.5; a=2.9; b=1.8

Solar Reflectance=0.27

Thermal Emittance=0.72

Reflective Gray Aluminum Flakes

A gray reflective coating composition 341-Al comprised:

| | As Prepared | | As Applied | |
|---|---|---|---|---|
| | (Before Dilution) | | (After 70/30 Dilution) | |
| | % by Wt. | % Solids | % by Wt. | % Solids |
| Water | 23.8 | 0.0 | 46.6 | 0.0 |
| Sodium Silicate N | 24.9 | 9.5 | 17.4 | 6.7 |
| Sodium Silicate D | 7.1 | 3.0 | 5.0 | 2.1 |
| BASF 9889 IR-Black | 11.4 | 11.4 | 8.0 | 8.0 |
| SMC 1100 Anatase | 11.4 | 11.4 | 8.0 | 8.0 |
| Kamin 95 Kaolin Slurry | 21.4 | 14.9 | 15.0 | 10.4 |
| Total | 100.0 | 50.2 | 100.0 | 35.2 |

The initial coating composition had a 50.2% solids content and a 810 centipoise viscosity. After dilution to a 70/30 (paint to water) ratio, the final solids content was 35.2% and the viscosity was 130 centipoise. Aluminum flake was coated with 341-Al until a 30% weight gain was realized. After 900° F. oven-curing, the coated flakes exhibited the following properties:

341-Al Grey Reflective Flake

Hunter Color L=35.7; a=2.7; b=0.4

Solar Reflectance 0.37

Thermal Emittance=0.69

An exposure panel surfaced with these 341-Al gray reflective flakes was placed in an Atlas Ci4000 Weatherometer and subjected to accelerated weathering by using the Atlas “Miami A” exposure protocol. Color, reflectance, and emittance were periodically measured throughout the exposure period as tabulated below:

341-Al Grey Reflective Flake-Surfaced Panel

| Weatherometer | | | | Solar | Thermal |
|---|---|---|---|---|---|
| Exposure Hours | L | a | b | Reflectance | Emittance |
| Initial | 35.5 | 2.7 | 0.3 | 0.37 | 0.69 |
| 2000 | 34.8 | 2.6 | 1.1 | — | — |
| 2400 | 34.8 | 2.7 | 1.1 | 0.35 | 0.70 |
| 2800 | 34.7 | 2.6 | 1.1 | — | — |
| 3200 | 34.7 | 2.6 | 1.0 | — | — |
| 3600 | 34.5 | 2.6 | 1.0 | — | — |
| 4000 | 33.6 | 2.7 | 1.1 | 0.34 | 0.70 |
| 4400 | 33.9 | 2.7 | 1.1 | — | — |
| 4800 | 33.5 | 2.7 | 1.2 | 0.34 | 0.72 |
| Change from | −2.0 | 0.0 | +0.9 | −0.03 | +0.03 |
| Initial: | | | | | |

After 4800 hours of weatherometer exposure, the 341-Al flakes have lost 8% of their initial reflectance as a result of the 2.0 point L-scale darkening. During this same period, thermal emittance increased 4%.

In a subsequent fluidized bed coating trial, the 341-Al formulation was diluted to a 60/40 (paint to water) ratio as shown below:

| | As Prepared | | As Applied | |
|---|---|---|---|---|
| | (Before Dilution) | | (After 60/40 Dilution) | |
| | % by Wt. | % Solids | % by Wt. | % Solids |
| Water | 23.8 | 0.0 | 54.3 | 0.0 |
| Sodium Silicate N | 24.9 | 9.5 | 14.9 | 5.7 |
| Sodium Silicate D | 7.1 | 3.0 | 4.3 | 1.8 |
| BASF 9889 IR-Black | 11.4 | 11.4 | 6.8 | 6.8 |
| SMC 1100 Anatase | 11.4 | 11.4 | 6.8 | 6.8 |
| Kamin 95 Kaolin Slurry | 21.4 | 14.9 | 12.9 | 8.9 |
| Total | 100.0 | 50.2 | 100.0 | 30.0 |

The final diluted formulation has a total solids content of 30.0% and a final viscosity of 80 centipoise and was similarly applied in the fluidized bed coater until a 30% aluminum flake weight gain was obtained. Preconditioning efforts were also made to improve coating coverage. This resulted in better coated flake of slightly darker-color, slightly lower reflectance but with improved emittance:

Darker 341-Al Gray Reflective Flake

Hunter Color L=32.8; a=2.8; b=0.8

Solar Reflectance=0.34

Thermal Emittance=0.71

Reflective White Aluminum Flakes

A white reflective coating composition 720-Al had the following composition:

| | As Prepared | | As Applied | |
|---|---|---|---|---|
| | (Before Dilution) | | (After 70/30 Dilution) | |
| | % by Wt. | % Solids | % by Wt. | % Solids |
| Water | 13.3 | 0.0 | 39.3 | 0.0 |
| Sodium Silicate N | 39.8 | 15.3 | 27.9 | 10.7 |
| Sodium Silicate D | 8.9 | 3.7 | 6.2 | 2.6 |
| Millenium RCL-9 TiO₂ | 17.7 | 17.7 | 12.4 | 12.4 |
| Kamin 95 Kaolin Slurry | 20.3 | 14.2 | 14.2 | 9.9 |
| Total | 100.0 | 50.9 | 100.0 | 35.6 |

The Initial coating composition had a 50.9% solids content and 610 centipoise viscosity. After dilution to a 70/30 (paint to water) ratio, the diluted formulation had a 35.6% solids content and a 120 centipoise viscosity. This diluted formulation was applied to fluidized aluminum flake until a 30% weight gain was obtained. After curing at 900° F. the colored flakes exhibited the following properties:

720-Al White Reflective Flake

Hunter Color L=75.0; a=−0.6; b=−1.0

Solar Reflectance=0.56

Thermal Emittance=0.71

Reflective Brown-Accent Tone Aluminum Flakes

A brown-accent tone reflective coating composition 801-Al was prepared:

| | As Prepared | | As Applied | |
|---|---|---|---|---|
| | (Before Dilution) | | (After 60/40 Dilution) | |
| | % by Wt. | % Solids | % by Wt. | % Solids |
| Water | 24.4 | 0.0 | 54.6 | 0.0 |
| Sodium Silicate N | 25.6 | 9.8 | 15.4 | 5.9 |
| Sodium Silicate D | 7.3 | 3.1 | 4.4 | 1.9 |
| BASF 9889 IR-Black | 11.7 | 11.7 | 7.0 | 7.0 |
| MPT1300 Red | 1.0 | 1.0 | 0.6 | 0.6 |
| Bayferrox 950 Yellow | 2.0 | 2.0 | 1.2 | 1.2 |
| SMC 1100 Anatase | 6.0 | 6.0 | 3.6 | 3.6 |
| Kamin 95 Kaolin Slurry | 22.0 | 15.4 | 13.2 | 9.2 |
| Total | 100.0 | 49.0 | 100.0 | 29.4 |

This initial coating composition (49.0% total solids) exhibited a viscosity of 800 centipoise. After dilution to a 60/40 (paint to water) ratio, the resulting paint had a 29.4% solids content and 70 centipoise viscosity. This diluted 801-Al formulation was applied to fluidized aluminum flake until a 30% weight gain was realized. Individual samples of the coated flakes were then cured by firing in a draw-down oven at 600° F., 750° F., 800° F., 850° F., 900° F., and 950° F. A plot of Alkalinity vs Curing Temperature for aluminum flakes coated with the 801-Al coating is also shown in FIG. 1. The same trend as with 340-Al is seen. These results confirm that a 900° F. curing temperature is sufficient to insolubilize (Alkalinity <20 ml) the coating and to provide the following colored flake properties:

801-Al Brown Accent Reflective Flake

Hunter Color l=30.7; a=3.2; b=2.8

Solar Reflectance=0.33

Thermal Emittance=0.71

In a subsequent trial, this same initial 801-Al coating formulation was diluted to a 50/50 (paint to water) ratio to a 24.5% solids ratio (above) and 40 centipoise viscosity. This diluted formulation was similarly applied in the fluidized bed coater until a 39% aluminum flake weight gain was obtained. This higher coating weight (thicker coating) resulted in a darker-colored flake with a lower reflectance and slightly higher emittance after 900° F. curing:

| | As Prepared | | As Applied | |
|---|---|---|---|---|
| | (Before Dilution) | | (After 50/50 Dilution) | |
| | % by Wt. | % Solids | % by Wt. | % Solids |
| Water | 24.4 | 0.0 | 62.2 | 0.0 |
| Sodium Silicate N | 25.6 | 9.8 | 12.8 | 4.9 |
| Sodium Silicate D | 7.3 | 3.1 | 3.7 | 1.6 |
| BASF 9889 IR-Black | 11.7 | 11.7 | 5.8 | 5.8 |
| MPT1300 Red | 1.0 | 1.0 | 0.5 | 0.5 |
| Bayferrox 950 Yellow | 2.0 | 2.0 | 1.0 | 1.0 |
| SMC 1100 Anatase | 6.0 | 6.0 | 3.0 | 3.0 |
| Kamin 95 Kaolin Slurry | 22.0 | 15.4 | 11.0 | 7.7 |
| Total | 100.0 | 49.0 | 100.0 | 24.5 |

Darker 801-Al Brown Accent Reflective Flake

Hunter Color L=28.9; a=3.4; b=2.9

Solar Reflectance=0.30

Thermal Emittance=0.72

Reflective Gray-Accent Tone Aluminum Flakes

A gray-accent tone reflective coating composition 801-Al(New) was prepared:

| | As Prepared | | As Applied | |
|---|---|---|---|---|
| | (Before Dilution) | | (After 60/40 Dilution) | |
| | % by Wt. | % Solids | % by Wt. | % Solids |
| Water | 24.5 | 0.0 | 54.8 | 0.0 |
| Sodium Silicate N | 25.4 | 9.7 | 15.2 | 5.8 |
| Sodium Silicate D | 7.2 | 3.0 | 4.3 | 1.8 |
| BASF 9889 IR-Black | 9.0 | 9.0 | 5.4 | 5.4 |
| Heubach 6R Yellow | 4.0 | 4.0 | 2.4 | 2.4 |
| Rockwood 4099 Green | 2.0 | 2.0 | 1.2 | 1.2 |
| SMC 1100 Anatase | 5.9 | 5.9 | 3.5 | 3.5 |
| Kamin 95 Kaolin Slurry | 22.0 | 15.4 | 13.2 | 9.2 |
| Total | 100.0 | 49.0 | 100.0 | 29.3 |

The initial composition (49.0% solids content, 710 centipoise viscosity) was diluted with water to a 60/40 (paint to water) ratio. The resulting paint (29.3% solids content and 70 centipoise Viscosity) was used to coat aluminum flake until a 30% weight gain was obtained. After curing at 900 F the colored flakes exhibited the following properties:

801-Al(New) Grey-Accent Tone Reflective Flake

Hunter Color L=33.0; a=1.4; b=4.7

Solar Reflectance=0.33

Thermal Emittance=0.72

Reflective Dark Brown Aluminum Flakes

The following dark brown reflective coating composition, designated 552-Al, was prepared:

| | As Prepared | | As Applied | |
|---|---|---|---|---|
| | (Before Dilution) | | (After 60/40 Dilution) | |
| | % by Wt. | % Solids | % by Wt. | % Solids |
| Water | 25.0 | 0.0 | 54.9 | 0.0 |
| Sodium Silicate N | 26.1 | 10.0 | 15.7 | 6.0 |
| Sodium Silicate D | 7.5 | 3.1 | 4.5 | 1.9 |
| BASF 9770 IR-Brown | 13.1 | 13.1 | 7.9 | 7.9 |
| SMC 1100 Anatase | 6.0 | 6.0 | 3.6 | 3.6 |
| Kamin 95 Kaolin Slurry | 22.3 | 15.7 | 13.4 | 9.4 |
| Total | 100.0 | 47.9 | 100.0 | 28.8 |

The initial coating composition (47.9% solids content, 840 centipoise viscosity) was diluted with water to a 60/40 (paint to water) ratio, which resulted in a paint of 28.8% solids content and 80 centipoise viscosity. The diluted 552-Al formulation was then used to coat aluminum flake until a 30% weight gain was obtained. After curing at 900° F. the colored flakes exhibited the following properties:

552-Al Dark Brown Reflective Flake

Hunter Color L=31.4; a=7.3; b=4.4

Solar Reflectance=0.34

Thermal Emittance=0.72

What is claimed is:

1. Colored metal particles comprising:
a) metallic base particles; and
b) an insolubilized coating material at least partially covering said particles comprising:
an IR-reflective pigment; and
a silicate-clay matrix formed from the high-temperature interaction between an alkali metal silicate and kaolin clay.

2. The colored metal particles of claim 1 wherein said metallic base is selected from the group consisting of aluminum, zinc, copper, tin, brass, bronze, stainless steel, alloys, and composites thereof.

3. The colored metal particles of claim 1 wherein said IR-reflective pigment comprises a pigment selected from the group consisting of zinc iron chromite spinel, iron titanium brown spinel, chromium green-black hematite, chromium iron oxide, chromium iron nickel black spinel, cobalt chromium green spinel, chromium titanate green spinel, cobalt aluminate blue spinel, and cobalt chromite blue-green spinel.

4. The colored metal particles of claim 1 wherein said insolubilized coating further comprises non-pigmentary TiO₂.

5. The colored metal particles of claim 4 wherein the non-pigmentary TiO₂ has the following particle size distribution:
% Finer than 40 microns=100%
% Finer than 10 microns=50-100%
% Finer than 1 microns=0-15%

6. The colored metal particles of claim 1 wherein the kaolin clay is present in an amount ranging from about 75% to 150% relative to the weight of alkali silica solids.

7. The colored metal particles of claim 1 wherein said coating comprises a pigment selected from the group consisting of titanium dioxide white, chrome titanate yellow, nickel titanate yellow, zinc ferrite yellow, red iron oxide, yellow iron oxide, chrome oxide green, ultramarine blue, and cobalt blue.

8. The colored metal particles of claim 1 wherein the metallic base particles are in the form of flakes.

9. The colored metal particles of claim 8 wherein the metallic base comprises aluminum.

10. The colored metal particles of claim 1 wherein the metallic base comprises aluminum.

11. The colored metal particles of claim 1 wherein said insolubilized coating comprises from about 20% to 40% by weight of the colored metal particles.

12. A method of preparing colored metal particles comprising:
a) coating metallic particles in one or multiple applications, with a semi-ceramic composition comprising (% by wt.) to produce uncured coated particles:
40-80 water
10 to 25 sodium silicate solution
0 to 15 non-pigmentary TiO₂
0 to 20 IR-reflective dark pigments
0 to 15 IR-reflective tint pigments
5 to 30 Kaolin clay,
b) heating the uncured coated particles to form an insolubilized silicate-clay matrix on the metallic particles to produce finished color coated particles.

13. The method of claim 12 wherein said metallic particles comprise a metal selected from the group consisting of aluminum, zinc, copper, tin, brass, bronze, stainless steel, alloys, and composites thereof.

14. The method of claim 12 wherein said semi-ceramic composition comprises at least one IR-reflective dark pigment selected from the group consisting of zinc iron chromite spinel, iron titanium brown spinel, chromium green-black hematite, chromium iron oxide, chromium iron nickel black spinel, cobalt chromium green spinel, chromium titanate green spinel, cobalt aluminate blue spinel, and cobalt chromite blue-green spinel.

15. The method of claim 12 wherein said particles have a Total Solar Reflectance of at least 25%.

16. The method of claim 12 wherein the semi-ceramic composition includes non-pigmentary TiO₂.

17. The method of claim 12 further comprising pre-drying the uncured, coated particles to a moisture content of about 0.2% to 0.5%.

18. The method of claim 12 wherein said finished color particles exhibit an extractable alkalinity of less than 20 ml 0.1 N HCl.

19. The method of claim 12 wherein said uncured, coated particles are heated to temperature of about 900° F. to 1000° F.

20. Roofing shingles comprising a substrate and the colored metal particles of claim 1 embedded or coated onto said substrate wherein said colored metal particles comprise at least one dark IR-reflective pigment selected from the group consisting of: zinc iron chromite spinel, iron titanium brown spinel, chromium green-black hematite, chromium iron oxide, chromium iron nickel black spinel, cobalt chromium green spinel, chromium titanate green spinel, cobalt aluminate blue spinel, and cobalt chromite blue-green spinel wherein said roofing shingles have a Total Solar Reflectance of at least 25%.

21. The roofing shingles of claim 20 wherein said metallic particles comprise aluminum.

22. The roofing shingles of claim 21 wherein said metallic particles are in the form of flakes.
